(19) United States
(12) Patent Application Publication
(10) Pub. No.: US 2021/0180978 A1
(43) Pub. Date: Jun. 17, 2021

(54) FACILITY INFORMATION DISPLAY SYSTEM, FACILITY INFORMATION DISPLAY DEVICE, AND FACILITY INFORMATION DISPLAY PROGRAM

(71) Applicant: TOYOTA JIDOSHA KABUSHIKI KAISHA, Toyota-shi (JP)

(72) Inventors: Xin JIN, Nagoya-shi (JP); Taiki NAKAMURA, Nagoya-shi (JP)

(73) Assignee: TOYOTA JIDOSHA KABUSHIKI KAISHA, Toyota-shi (JP)

(21) Appl. No.: 17/080,028

(22) Filed: Oct. 26, 2020

(30) Foreign Application Priority Data
Dec. 11, 2019 (JP) 2019-224012

(51) Int. Cl. G01C 21/36

(52) U.S. Cl. CPC G01C 21/3682; G01C 21/367; G01C 21/3697; G01C 21/3617

(57) ABSTRACT

A facility information display system includes: a server device including a first processor having hardware, the first processor being configured to acquire, from a vehicle, information regarding a current location of the vehicle, and output, to a display terminal provided in the vehicle, facility information regarding one or more facilities located around the vehicle; and the display terminal including a display and a second processor, the second processor having hardware, the second processor being configured to display a map including the location of the vehicle on the display, and to display, out of the facility information acquired from the server device, facility information on a facility located ahead of the vehicle on the display such that the facility information is superimposed on the map.

### INCORPORATION BY REFERENCE

The disclosure of Japanese Patent Application No. 2019-224012 filed on Dec. 11, 2019 including the specification, drawings and abstract is incorporated herein by reference in its entirety.

### BACKGROUND

### 1. Technical Field

The present disclosure relates to a facility information display system, a facility information display device, and a facility information display program.

### 2. Description of Related Art

Disclosed in Japanese Patent Application Publication No. 2009-25223 is a navigation device. When a vehicle enters into a prescribed tourist area, the navigation device eliminates, on a map screen, landmarks indicating facilities located around the vehicle, displays icons of tourist facilities including current date and time as a display period, and displays a trend information button on some of the icons.

### SUMMARY

It has been demanded to indicate information in accordance with the situation of a vehicle, an occupant's preference and the like, in addition to indicating the trend information, on the map screen.

The present disclosure has been made in view of the above demand, and it is an object of the present disclosure to provide a facility information display system, a facility information display device, and a facility information display program, capable of displaying information in accordance with the situation of a vehicle, an occupant's preference, and the like.

A facility information display system according to the present disclosure includes: a server device including a first processor; and a display terminal including a display and a second processor. The first processor has hardware. The first processor is configured to acquire, from a vehicle, information regarding a current location of the vehicle, and output, to the display terminal provided in the vehicle, facility information regarding one or more facilities located around the vehicle. The second processor has hardware. The second processor is configured to display a map including the location of the vehicle on the display, and to display, out of the facility information acquired from the server device, facility information on a facility located ahead of the vehicle on the display such that the facility information is superimposed on the map.

A facility information display device according to the present disclosure includes a display and a processor having hardware. The processor is configured to display a map including a location of a vehicle on the display, and to display, out of facility information regarding one or more facilities located around the vehicle acquired from a server device, facility information on a facility located ahead of the vehicle on the display such that the facility information is superimposed on the map.

A facility information display program according to the present disclosure causes a processor having hardware to execute: displaying a map including a location of a vehicle on a display, and displaying, out of facility information regarding one or more facilities located around the vehicle acquired from a server device, facility information on a facility located ahead of the vehicle on the display such that the facility information is superimposed on the map.

According to the present disclosure, it is possible to display information in accordance with the situation of a vehicle, an occupant's preference, and the like.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 schematically shows a facility information display system according to an embodiment;

FIG. 2 is a block diagram schematically showing the configuration of the facility information display system according to the embodiment;

FIG. 3 is a flowchart showing processing procedures of a facility information display method executed by the facility information display system, a facility information display device, and a facility information display program according to the embodiment;

FIG. 4 shows an example of a method of switching facility information that is displayed on a display unit so as to be superimposed on a map in the facility information display method according to the embodiment;

FIG. 5 shows an example in which facility information on facilities located ahead of a vehicle is displayed on the display unit such that the facility information is superimposed on the map in the facility information display method according to the embodiment;

FIG. 6 shows an example of a screen that displays detailed facility information in the facility information display method according to the embodiment;

FIG. 7 shows an example in which facility information on the facilities along a guide route is displayed on the display unit such that the facility information is superimposed on the map in the facility information display method according to the embodiment; and

FIG. 8 shows an example in which facility information on facilities different in kind from a facility that is set as a destination by a user is displayed on the display unit such that the facility information is superimposed on the map in the facility information display method according to the embodiment.

### DETAILED DESCRIPTION OF EMBODIMENTS

A facility information display system, a facility information display device, and a facility information display program according to an embodiment of the present disclosure will be described with reference to the drawings. Component members in the following embodiments include those that can be replaced or be easily replaced by those skilled in the art, or those substantially identical.

Facility Information Display System and Facility Information Display Device

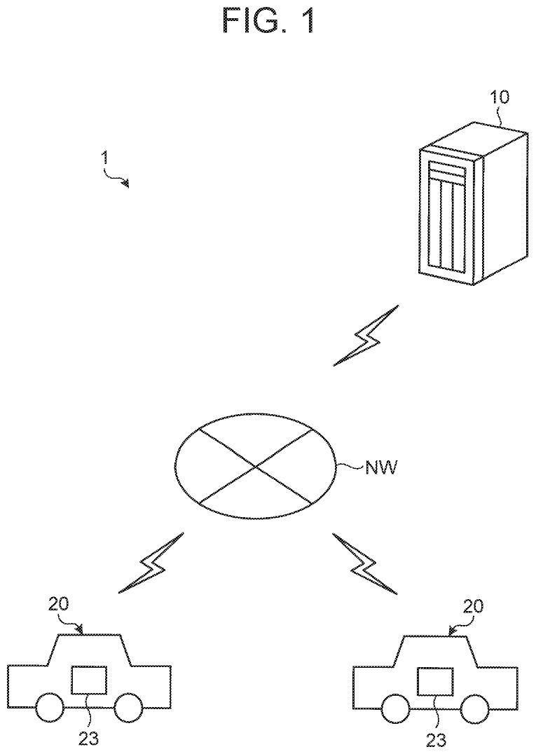

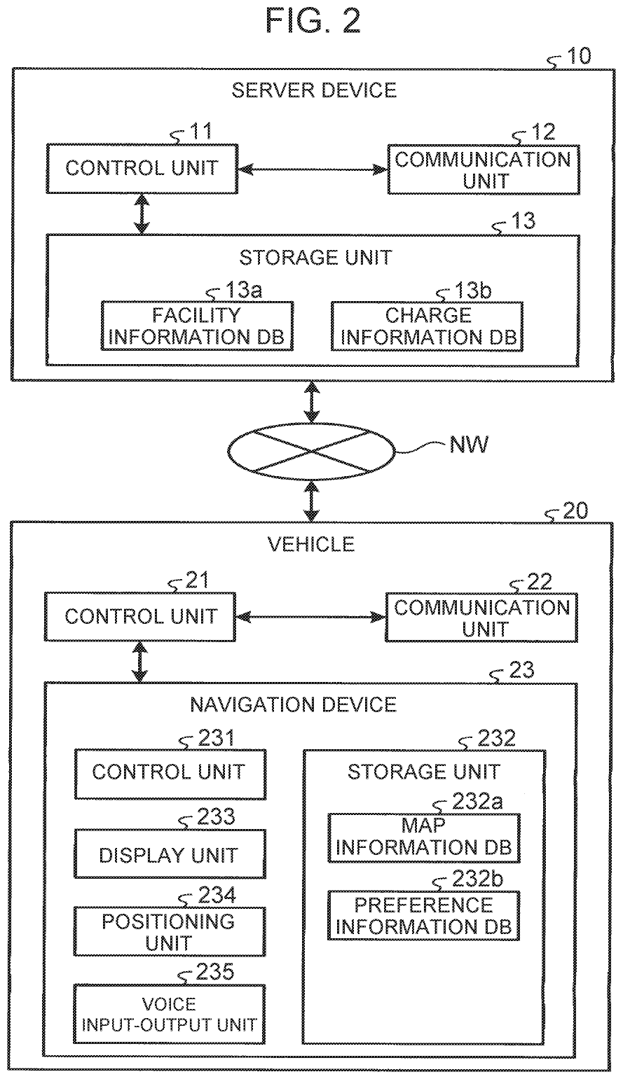

The configuration of a facility information display system and a facility information display device according to the present embodiment will be described with reference to FIGS. 1 and 2. The facility information display system, the facility information display device, and a facility information display program according to the present embodiment are configured to provide, together with information on a map around a vehicle, information (hereinafter called “facility information”) regarding one or more facilities located on the map to a user through a display terminal provided in the vehicle. The term “user” refers to occupants including a driver of the vehicle.

As shown in FIG. 1, a facility information display system 1 has a server device 10 and vehicles 20 each including a navigation device (display terminal) 23. Specifically, the facility information display device according to the present embodiment is implemented by the navigation device 23. The server device 10 and the vehicle 20 are configured so as to be communicable with each other through a network NW. The network NW is constituted of, for example, an Internet line network, a mobile phone line network, and the like.

Server Device

As shown in FIG. 2, the server device 10 includes a control unit 11, a communication unit 12, and a storage unit 13. Specifically, the control unit 11 includes a processor formed with a central processing unit (CPU), a digital signal processor (DSP), a field-programmable gate array (FPGA), or the like. The control unit 11 also includes a memory (primary storage) formed with a random-access memory (RAM), a read-only memory (ROM), or the like.

The control unit 11 implements functions conformable to prescribed purposes, by loading a program stored in the storage unit 13 to a work area of the primary storage, and executing the program such that respective component units are controlled through the execution of the program.

The control unit 11 acquires information (hereinafter called “vehicle location information”) regarding a current location of the vehicle 20 from a navigation device 23 that is provided in the vehicle 20. The control unit 11 also outputs, based on the vehicle location information, facility information regarding one or more facilities located around the vehicle 20 to the navigation device 23 through the communication unit 12.

The communication unit 12 is constituted of, for example, a local area network (LAN) interface board, a wireless communication circuit for wireless communication, or the like. The communication unit 12 is connected to a network NW, such as the Internet which is a public communication network. The communication unit 12 communicates with the vehicles 20 by connecting to the network NW.

The storage unit 13 is constituted of an erasable programmable ROM (EPROM), a hard disk drive (HDD), and a removable medium, or the like. Examples of the removable medium include a universal serial bus (USB) memory and a disc recording medium, such as a compact disc (CD), a digital versatile disc (DVD), and a Blu-ray (registered trademark) disc (BD). The storage unit 13 can store an operating system (OS), various programs, various tables, various databases, and the like.

The storage unit 13 includes a facility information DB 13a and a charge information DB 13b. These databases (DB) are constructed when a program of a database management system (DBMS) that is executed by the control unit 11 manages the data stored in the storage unit 13.

For example, the facility information DB 13a is constituted of a relational database in which a plurality of facility information pieces are retrievably stored. The facility information is information regarding a facility that is located on a map. The facility information includes, for example, the name of the facility, the location of the facility, parking lot availability, takeout service availability, coupon availability, availability of kids menu (in case of eating place), accessibility by wheelchair, available settlement means, the presence of no smoking policy inside facility, regular prices of food and beverages (in case of eating place), fixed holidays, business hours, and the number of customers waiting to enter, and the like. As for dynamic information (for example, the number of customers waiting to enter, etc.) in the facility information, the server device 10 periodically acquires latest information from a separate server that manages the facility information, and updates the facility information DB 13a each time.

The charge information DB 13b is constituted of, for example, a relational database that retrievably stores a plurality of charge information pieces. The charge information is information regarding whether each facility pays an operator of the facility information display system 1 a charge for displaying the facility information, for example.

Vehicle

The vehicle 20 includes a control unit 21, a communication unit 22, and the navigation device 23. The control unit 21 has a physical configuration similar to the control unit 11. The control unit 21 is an electronic control unit (ECU) that collectively controls operation of various component members mounted in the vehicle 20. The communication unit 22 is constituted of, for example, a data communication module (DCM) or the like to communicate with the server device 10 by wireless communication through the network NW.

The navigation device 23 receives and outputs data, such as map information and travel route information, a navigation program and the like, from and to the control unit 21. Thus, the control unit 21 controls the vehicle 20 to travel by supplying various command signals to the component members constituting the vehicle 20. The navigation device 23 includes a control unit 231, a storage unit 232, a display unit 233, a positioning unit 234, and a voice input-output unit 235.

The control unit 231 and the storage unit 232 have physical configuration similar to the control unit 11 and the storage unit 13. The control unit 231 controls a display content on the display unit 233. Specifically, the control unit 231 displays a map including the location of the vehicle 20 on the display unit 233, and displays the facility information acquired from the server device 10 on the display unit 233 such that the facility information is superimposed on the map.

The storage unit 232 includes a map information DB 232a and a preference information DB 232b. These databases (DB) are constructed when a program of a database management system that is executed by the control unit 231 manages the data stored in the storage unit 232. The storage unit 232 also stores the vehicle location information detected by the positioning unit 234 as necessary.

For example, the map information DB 232a is constituted of a relational database in which map information is retrievably stored. The preference information DB 232b is constituted of, for example, a relational database that retrievably stores user's preference information. For example, the preference information refers to the facility information displayed to the user in the past or the facility information on a facility visited by the user in the past.

The display unit 233 is constituted of a liquid crystal display (LCD), an organic EL display (OLED) or the like. Under the control of the control unit 231, the display unit 233 displays a map including the location of the vehicle 20, a road on which the vehicle 20 currently travels, a guide route to a destination, facility information on facilities on the map and the like. The display unit 233 may be a touch panel display which receives an input by the user.

The positioning unit 234 receives electric waves from global positioning system (GPS) satellites, and detects vehicle location information. In response, the control unit 21 periodically outputs vehicle location information to the server device 10 through the network NW. A method of detecting the vehicle location information is not limited to the method using the GPS satellites. For example, such a method as combining a light detection and ranging or laser imaging detection and ranging (LiDAR) and a three-dimensional digital map may be used.

The voice input-output unit 235 is constituted of, for example, a speaker microphone or the like. The voice input-output unit 235 notifies the current location of the vehicle 20 acquired by the positioning unit 234, the name of the road on which the vehicle 20 currently travels, a guide route to the destination, the information on facilities on the map and the like, to the user by voice. The voice input-output unit 235 also inputs prescribed information to the control unit 231 by acquiring the voice uttered by the user.

Facility Information Display Method

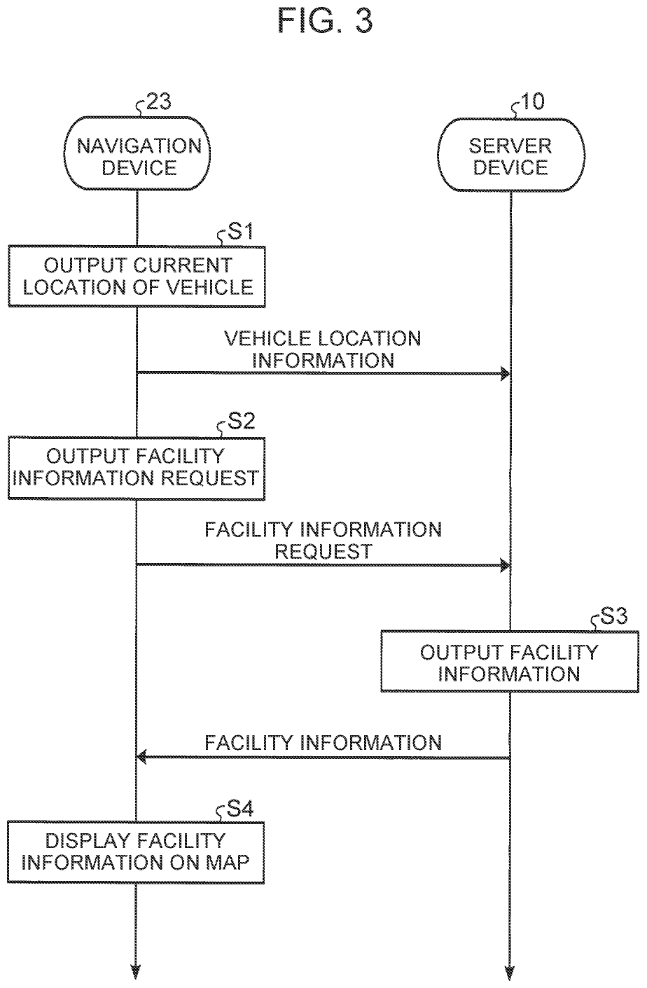

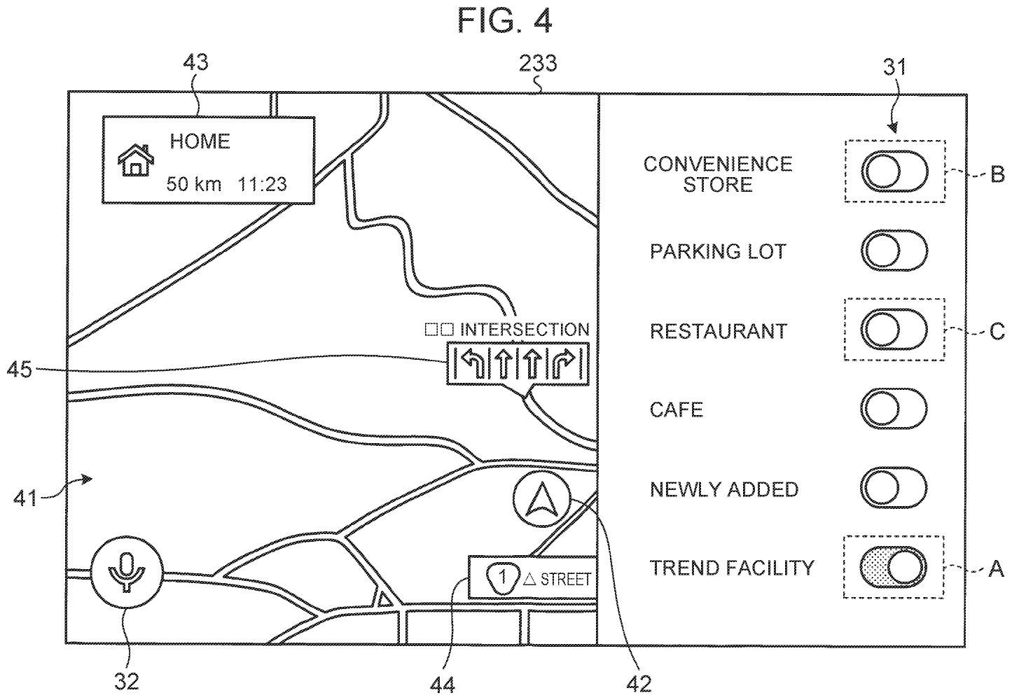

A facility information display method executed by the facility information display system 1 and the facility information display device according to the present embodiment will be described with reference to FIGS. 3 and 4.

First, the control unit 231 of the navigation device 23 periodically outputs the current location of the vehicle 20 acquired by the positioning unit 234 to the server device 10 (step S1). Next, the control unit 231 outputs a facility information request for requesting the information on facilities located around the vehicle 20 to the server device 10 (step S2).

Here, the control unit 231 displays on the display unit 233 information as shown in FIG. 4, for example. In the drawing, reference numeral 31 denotes display areas 31 that display buttons used to select facility information displayed on the display unit 233, reference numeral 32 denotes an icon 32 used for inputting voice, reference numeral 41 denotes a map 41, reference numeral 42 denotes an icon 42 indicating the location of the own vehicle, reference numeral 43 denotes a display area 43 in which a distance to home, current time and the like are displayed, reference numeral 44 denotes a display area 44 in which the names of roads are displayed, and reference numeral 45 denotes a display area 45 in which the names of intersections are displayed.

In step S2, for example, as shown in a section A of FIG. 4, the user slides the button of facilities that the user wants to display (slides rightward in FIG. 4) in the display area 31. In response to this action, the control unit 231 outputs a request (hereinafter, referred to as “facility information request”) that is to request facility information on the facilities to the server device 10.

Next, the server device 10 outputs facility information included in the facility information request to the navigation device 23 (step S3). The control unit 231 then displays the acquired facility information on the display unit 233 such that the facility information is superimposed on the map (step S4).

Display Example of Facility Information Display

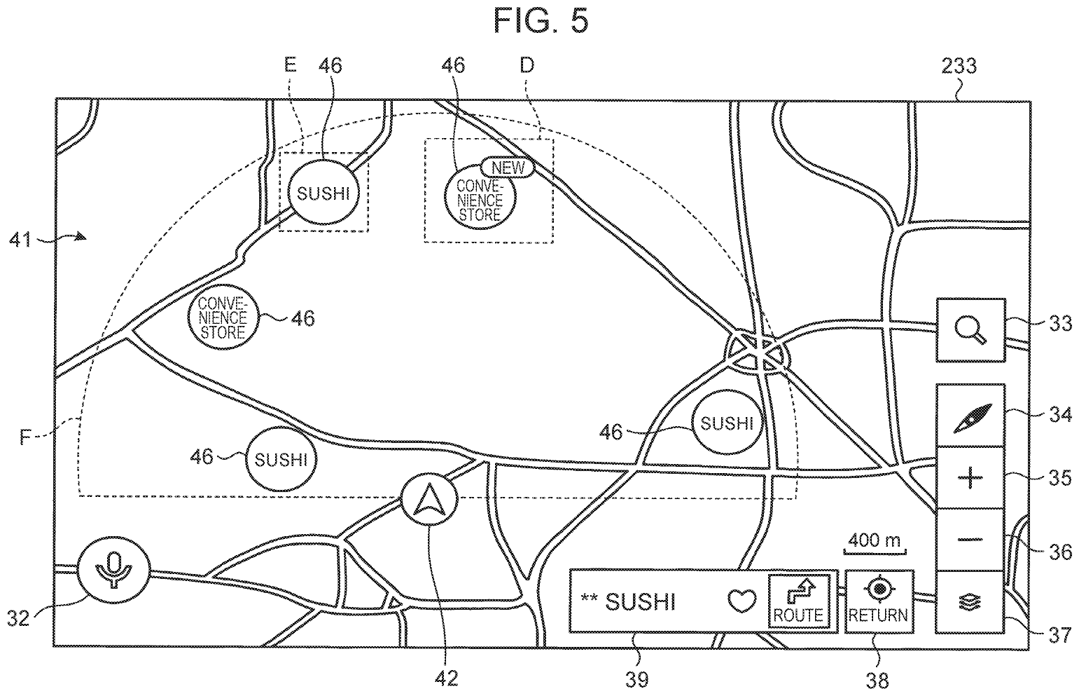

How to display the facility information in step S4 of the facility information display method according to the present embodiment will be described with reference to FIGS. 5 to 8.

As shown in FIG. 5, the control unit 231 of the navigation device 23 displays icons 46 of the facilities in the facility information acquired from the server device 10 on the display unit 233 such that the icons 46 is superimposed on the map 41. FIG. 5 shows an example in the case where, for example, a user slides a “trend facility” button, a “convenience store” button, and a “restaurant” button shown in sections A to C of FIG. 4, and thereby facility information on corresponding facilities (convenience stores and sushi restaurants) is output to the navigation device 23 from the server device 10.

Here, the term “trend facility” refers to the facilities under the situation different from normal situation, such as newly opened facilities, reopened facilities after redecoration, facilities during events, facilities during a sale (bargain sale), and facilities popular in social networking service (SNS). For example, the icon 46 representing a newly opened facility, out of the trend facilities, has a character string “NEW” added thereto as shown by a section D of FIG. 5. The icon 46 representing a facility during an event, out of the trend facilities, has a character string, such as “EVENT”, added thereto, the icon 46 representing a facility during a sale has a character string, such as “SALE”, added thereto, and the icon 46 representing a facility that is popular in SNS has a character string, such as “SNS”, added thereto.

In FIG. 5, reference numeral 33 denotes an icon 33 used to search for facilities or the like. Reference numeral 34 denotes an icon 34 indicating an azimuth. Reference numeral 35 denotes an icon 35 used for expanding a contraction scale of the map 41. Reference numeral 36 denotes an icon 36 used for contracting the contraction scale of the map 41. Reference numeral 37 denotes an icon 37 for switching a plurality of types of maps (for example, a standard map and an air map) 41. Reference numeral 38 demotes an icon 38 used for returning the display of the map 41 to the display based on the location of the own vehicle. Reference numeral 39 denotes a display area 39 in which the facility selected on the map 41 is displayed. The reference numeral 46 denotes the icon 46 indicating a facility.

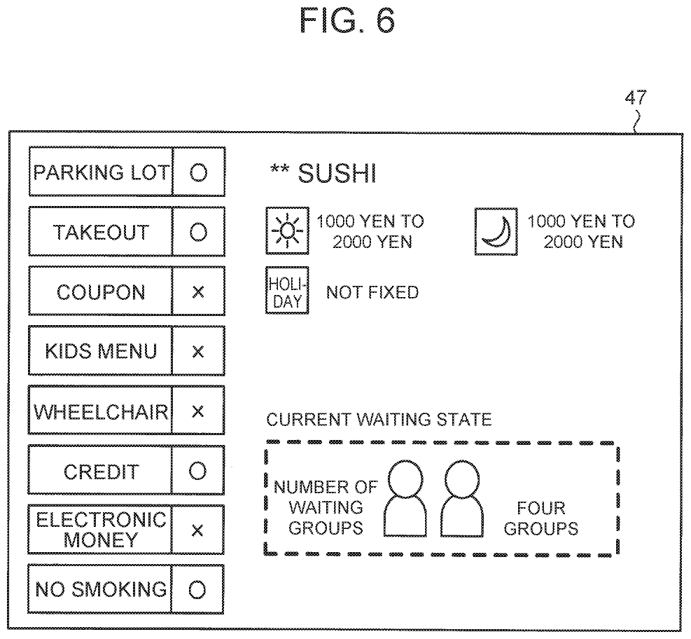

In FIG. 5, when the user selects the icon 46 of a certain facility, detailed information on the selected facility is displayed. For example, when the user selects the icon 46 representing a sushi restaurant shown in a section E of FIG. 5, the control unit 231 displays on the display unit 233 detailed facility information 47 as shown in FIG. 6. The detailed facility information 47 includes, for example, the name of the facility, the location of the facility, parking lot availability, takeout service availability, coupon availability, availability of kids menu (in case of eating place), accessibility by wheelchair, available settlement means, the presence of no smoking policy inside facility, regular prices of food and beverages (in case of eating place), fixed holidays, business hours, and the number of customers waiting to enter, and the like. The content included in the detailed facility information 47 varies depending on the kinds of the facilities. See FIG. 5 again for further description.

The control unit 231 displays on the display unit 233 the map 41 including the location of the vehicle 20. The control unit 231 displays, out of the facility information acquired from the server device 10, facility information on facilities located ahead of the vehicle 20 on the display unit 233 such that the facility information is superimposed on the map 41.

Here, the phrase “ahead of the vehicle 20” refers to a region positioned ahead with respect to a direction orthogonal to an advance direction of the vehicle 20. For example, as shown by a section F in FIG. 5, the phrase “ahead of the vehicle 20” can be expressed as a semicircular (or fan-shaped) region having a prescribed radius around the vehicle 20. The region is a semicircular (or fan-shaped) region cut out along the direction (advance direction) of the vehicle 20 with the vehicle 20 as a peak. Therefore, the phrase “facility information on the facility located ahead of the vehicle 20” indicates the facility information included in a semicircular (or fan-shaped) region having a prescribed radius with the vehicle 20 as a peak as shown in the section F in the drawing.

The display range of the facility information is not limited to the semicircular shape (or the fan-shape) shown in FIG. 5. For example, the display range may be a rectangular shape, a triangular shape, and the like. Thus, in the facility information display system 1, only the facility information on the facilities located ahead of the vehicle 20 is displayed on the display unit 233 such that the facility information is superimposed on the map 41. This makes it possible to display only the facility information on the facilities that the vehicle 20 (the user who is riding in the vehicle 20) may visit from now on, that is, only the facility information useful for the user.

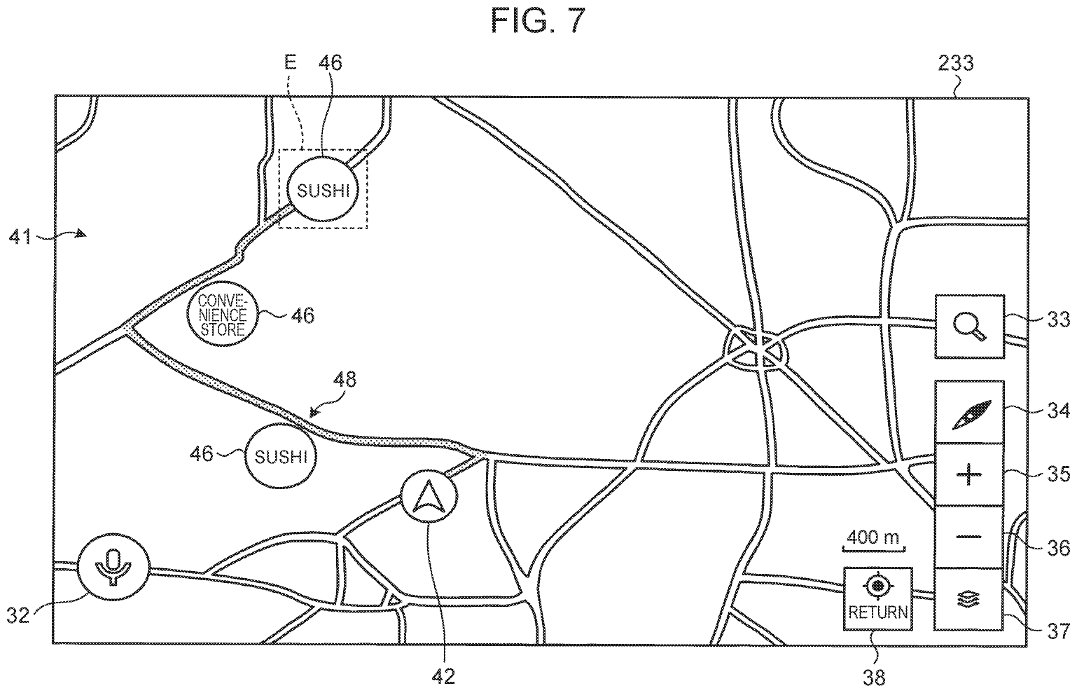

The control unit 231 may display, out of the facility information acquired from the server device 10, facility information on facilities along a guide route from the current location of the vehicle 20 to a destination set by the user on the display unit 233, such that the facility information is superimposed on the map 41. For example, when the user sets the sushi restaurant shown in a section E of FIG. 7 as a destination, the control unit 231 displays a guide route 48 to the destination on the display unit 233 such that the guide route is superimposed on the map 41. Then, the control unit 231 displays only the icons 46 representing the facilities in the vicinity of the guide route 48 on the map 41, and does not display the icons 46 representing the facilities not in the vicinity of the guide route 48. Thus, in the facility information display system 1, only the facility information along the guide route 48 is displayed on the map 41. This makes it possible to display only the facility information on the facilities that the vehicle 20 (the user who is riding the vehicle 20) may visit until reaching the destination, that is, only the facility information useful for the user.

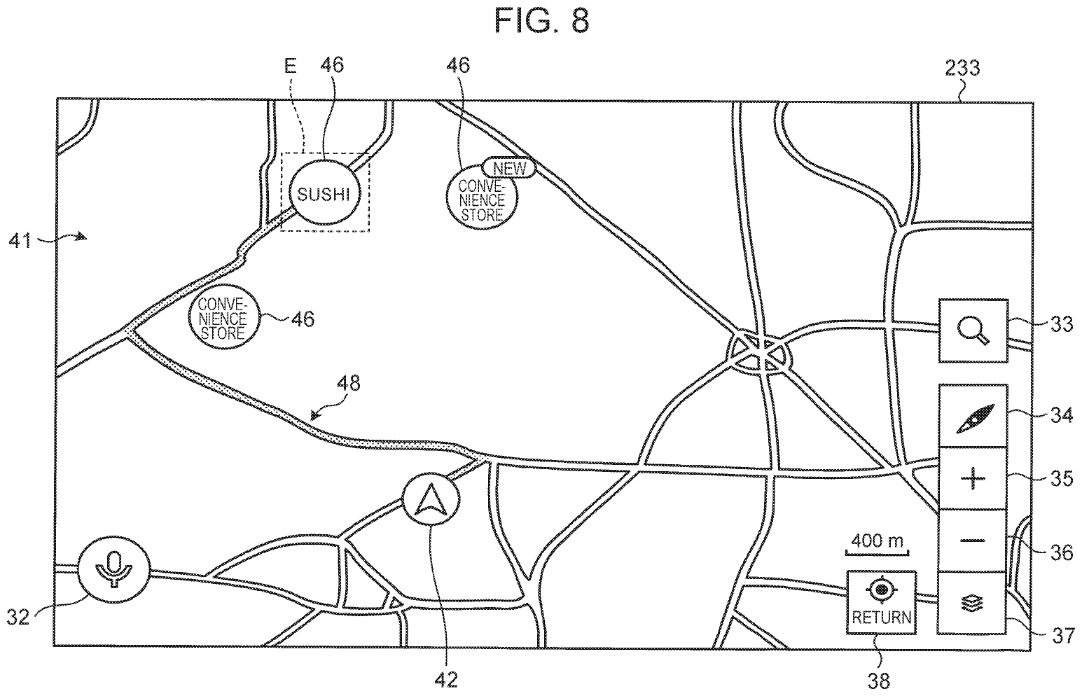

The control unit 231 may display, out of the facility information acquired from the server device 10, facility information on the facilities different in kind from the facility set as a destination by the user, on the display unit 233 such that the facility information is superimposed on the map 41. For example, when the user sets a sushi restaurant shown in a section E of FIG. 8 as a destination, the control unit 231 displays only the icons 46 representing the facilities different in kind from the destination (other than the sushi restaurant in the drawing) on the map 41, and does not display the icons 46 representing the facilities of the same kind as the destination (the sushi restaurant in the drawing). Thus, in the facility information display system 1, only the facility information on the facilities different in kind from the destination is displayed on the map 41, and the facility information on the facilities that are identical in kind to the destination and that are less likely to be visited by the vehicle 20 (the user who is riding the vehicle 20) is not displayed. This makes it possible to display only the facility information on the facilities that the vehicle 20 may visit, that is, only the facility information useful for the user.

The control unit 231 may display, out of the facility information acquired from the server device 10, facility information coinciding with the user's preference on the display unit 233 such that the facility information is superimposed on the map 41. In this case, the control unit 231 accumulates the facility information displayed to the user in the past, or the facility information on the facilities visited by the user in the past in the preference information DB 232b of the storage unit 232 as preference information regarding the user. When the user slides the button in the display area 31 of FIG. 4, the control unit 231 displays only the icons 46 representing the facilities coinciding with the user's preference information on the map 41, and does not display the icons 46 representing the facilities which do not coincide with the user's preference information. Thus, in the facility information display system 1, only the facility information coinciding with the user's preference is displayed on the map 41, and thereby only the facility information interesting to and useful for the user can be displayed.

The control unit 231 may switch the facility information displayed on the display unit 233 so as to be superimposed on the map 41 in accordance with charge information regarding each facility. In this case, when outputting the facility information to the navigation device 23, the control unit 11 of the server device 10 also outputs the charge information that is information indicating the presence or absence of payment of a charge by each facility, together with the facility information. In response to the output, the control unit 231 displays only the icons 46 representing the facilities that pay a charge on the map 41, and does not display the icons 46 representing the facilities that do not pay a charge. Thus, in the facility information display system 1, it is possible to selectively display only the facility information on the facilities that pay the operator of the facility information display system 1 a charge for displaying the facility information or the like on the map 41.

The control unit 231 may switch the facility information displayed on the display unit 233 so as to be superimposed on the map 41 depending on a time slot. In this case, depending on types of facilities, the time slot for displaying the facility information on the facilities is set in advance. For example, in the case of cafes, a time slot of morning or noon is set, and in the case of sushi restaurants, a time slot of evening is set. When the user slides the button in the display area 31 of FIG. 4, the control unit 231 displays only the icons 46 representing the facilities set for the time slot on the map 41, and does not display the icons 46 representing the facilities not set in the time slot. Thus, in the facility information display system 1, appropriate facility information is displayed for every time slot, and thereby only the facility information on facilities that the vehicle 20 may visit, that is, the facility information useful for the user, can be displayed.

The control unit 231 displays the map 41 on the display unit 233 with a contraction scale set in advance by the user. The control unit 231 displays a preset number or less of the facility information pieces on the display unit 233 such that the facility information is superimposed on the map 41 irrespective of the contraction scale of the map 41. For example, when the user operates the icons 35, 36 shown in FIG. 5, the control unit 231 displays the map 41 on the display unit 233 with a specified contraction scale. Meanwhile, the control unit 231 displays a preset number or less of the facility information pieces on the map 41 both in the case where the contraction scale of the map 41 is expanded and the case where the contraction scale of the map 41 is contracted. Specifically, the control unit 231 performs display control such that the display density of facility information is constant at every contraction scale. Hence, when, for example, the map 41 is contracted, it is possible to restrain the icons 46 representing the facilities from being overlapped and becoming hardly visible.

When there is priority information to be displayed to the user in preference to the facility information, the control unit 231 may display the priority information in place of the facility information on the display unit 233 such that the priority information is superimposed on the map 41. For example, when there is information (priority information) indispensable to driving of the vehicle 20, such as frequent occurrence of accidents in an area that the vehicle 20 heads for, construction works underway in an area that the vehicle 20 heads for, the control unit 231 may display the priority information instead of the facility information on the display unit 233. Thus, in the facility information display system 1, priority information is displayed in place of the facility information on the map 41, which makes it possible to restrain that the driving of the vehicle 20 is compromised.

The facility information display system 1, the facility information display device, and the facility information display program according to the present embodiment described in forgoing can display information in accordance with the situation of the vehicle 20 and the preference of the occupant.

Further effects and modifications can easily be derived by those skilled in the art. Accordingly, broader aspects of the disclosure are not limited to the specific details and typical embodiments as expressed and described above. Therefore, various modifications are possible, without departing from the spirit or scope of the overall concept of the disclosure that is defined by following claims and any equivalents thereof

What is claimed is:

1. A facility information display system, comprising:
a server device including a first processor having hardware, the first processor being configured to acquire, from a vehicle, information regarding a current location of the vehicle, and output, to a display terminal provided in the vehicle, facility information regarding one or more facilities located around the vehicle; and
the display terminal including a display and a second processor, the second processor having hardware, the second processor being configured to display a map including the location of the vehicle on the display, and to display, out of the facility information acquired from the server device, facility information on a facility located ahead of the vehicle on the display such that the facility information is superimposed on the map.

2. The facility information display system according to claim 1, wherein the second processor is configured to
display a guide route from the current location of the vehicle to a destination set by a user on the display such that the guide route is superimposed on the map, and
display, out of the facility information, facility information on a facility along the guide route on the display such that the facility information is superimposed on the map.

3. The facility information display system according to claim 2, wherein the second processor is configured to display, out of the facility information, facility information on a facility different in kind from a facility set as a destination by the user on the display such that the facility information is superimposed on the map.

4. The facility information display system according to claim 1, wherein the second processor is configured to
accumulate in a storage unit facility information displayed in a past as user's preference information, and
display, out of the facility information, facility information coinciding with the preference information on the display such that the facility information is superimposed on the map.

5. The facility information display system according to claim 1, wherein:
the first processor is configured to output, with the facility information, charge information indicating presence or absence of payment of a charge by each of the facilities to the display terminal; and
the second processor is configured to switch the facility information displayed on the display in accordance with the charge information.

6. The facility information display system according to claim 1, wherein the second processor is configured to switch the facility information displayed on the display depending on a time slot.

7. The facility information display system according to claim 1, wherein the second processor is configured to
display the map on the display with a contraction scale preset by the user, and
display a preset number or less of facility information pieces on the display such that the facility information is superimposed on the map irrespective of the contraction scale of the map.

8. The facility information display system according to claim 1, wherein when there is priority information to be displayed to the user in preference to the facility information, the second processor is configured to display the priority information in place of the facility information on the display such that the priority information is superimposed on the map.

9. A facility information display device, comprising a display and a processor having hardware, wherein
the processor is configured to
display a map including a location of a vehicle on the display, and
display, out of facility information regarding one or more facilities located around the vehicle acquired from a server device, facility information on a facility located ahead of the vehicle on the display such that the facility information is superimposed on the map.

10. The facility information display device according to claim 9, wherein the processor is configured to
display a guide route from a current location of the vehicle to a destination set by a user on the display such that the guide route is superimposed on the map, and
display, out of the facility information, facility information on a facility along the guide route on the display such that the facility information is superimposed on the map.

11. The facility information display device according to claim 10, wherein the processor is configured to display, out of the facility information, facility information on a facility different in kind from a facility set as a destination by the user such that the facility information is superimposed on the map.

12. The facility information display device according to claim 9, wherein the processor is configured to
accumulate in a storage unit facility information displayed in a past as user's preference information, and
display, out of the facility information, facility information coinciding with the preference information on the display such that the facility information is superimposed on the map.

13. The facility information display device according to claim 9, wherein the processor is configured to
acquire charge information indicating presence or absence of payment of a charge by each of the facilities from the server device, and
switch the facility information displayed on the display in accordance with the charge information.

14. The facility information display device according to claim 9, wherein the processor is configured to switch the facility information displayed on the display depending on a time slot.

15. The facility information display device according to claim 9, wherein the processor is configured to
display the map on the display with a contraction scale preset by the user, and
display a preset number or less of facility information pieces on the display such that the facility information is superimposed on the map irrespective of the contraction scale of the map.

16. The facility information display device according to claim 9, wherein when there is priority information to be displayed to the user in preference to the facility information, the processor is configured to display the priority information in place of the facility information on the display such that the priority information is superimposed on the map.

17. A facility information display program for causing a processor having hardware to execute:
displaying a map including a location of a vehicle on a display; and
displaying, out of facility information regarding one or more facilities located around the vehicle acquired from a server device, facility information on a facility located ahead of the vehicle on the display such that the facility information is superimposed on the map.

18. The facility information display program according to claim 17, for causing the processor to execute:
displaying a guide route from a current location of the vehicle to a destination set by a user on the display such that the guide route is superimposed on the map; and
displaying, out of the facility information, facility information on a facility along the guide route on the display such that the facility information is superimposed on the map.

19. The facility information display program according to claim 18, for causing the processor to execute displaying, out of the facility information, facility information on a facility different in kind from a facility set as a destination by the user on the display such that the facility information is superimposed on the map.

20. The facility information display program according to claim 17, for causing the processor to execute:
accumulating in a storage unit facility information displayed in a past as user's preference information; and
displaying, out of the facility information, facility information coinciding with the preference information on the display such that the facility information is superimposed on the map.
